(19) United States
(12) Patent Application Publication
(10) Pub. No.: US 2026/0339271 A1
(43) Pub. Date: Oct. 29, 2026

(54) ELECTRONIC TIMEPIECE

(71) Applicant: CITIZEN WATCH CO., LTD., Tokyo (JP)

(72) Inventors: Yuta FURUDATE, Tokorozawa-shi (JP); Kento NAKASE, Tokyo (JP); Naoki SEKIGUCHI, Tokyo (JP)

(21) Appl. No.: 19/544,998

(22) Filed: Feb. 19, 2026

(30) Foreign Application Priority Data
Mar. 18, 2025 (JP) 2025-043729

(51) Int. Cl. G04C 23/08; G04C 23/06; G04C 23/10; G04G 21/00

(52) U.S. Cl. CPC G04C 23/08; G04C 23/06; G04C 23/10; G04G 21/00

(57) ABSTRACT

An electronic timepiece includes a function hand, a plurality of function display sections provided to correspond to hand drive angles of the function hand, and a hand-driving mechanism configured to drive the function hand at each first hand drive angle, which is a first integer multiple of a unit hand drive angle, such that the function hand indicates each of a first number of positions arranged at equal intervals. The plurality of function display sections are provided in a second number that is greater than the first number. The function hand is capable of moving at hand drive angles that include a second hand drive angle, which is a second integer multiple of the unit hand drive angle, and a third hand drive angle, which is a third integer multiple of the unit hand drive angle and greater than the second hand drive angle.

### CROSS-REFERENCE TO RELATED APPLICATION

The present application claims priority from Japanese application No. 2025-043729 filed on Mar. 18, 2025, the content of which is hereby incorporated by reference into this application.

### BACKGROUND OF THE INVENTION

### 1. Field of the Invention

The present invention relates to an electronic timepiece.

### 2. DESCRIPTION OF THE RELATED ART

JP2008-203134A discloses an electronic timepiece having mode display means for displaying an operation mode. The mode display means includes a function hand, which is an analog indicator, allowing the user to check the currently selected mode (function) based on the position indicated by the function hand.

It is known in the art that electronic timepieces have six function display sections arranged at equal angular intervals. In such a configuration, it is preferable to drive the function hand in increments of 60°. A hand drive angle of 60° can be achieved by driving the hand consecutively ten times when the hand-driving mechanism including a wheel train is designed such that the unit hand drive angle is set to 6°.

In a configuration in which eight function display sections are arranged at equal angular intervals, the function hand needs to be driven in increments of 45°. However, 45° is not an integer multiple of 6°, and thus the above-described hand-driving mechanism configured for a unit hand drive angle of 6° cannot be applied. As such, the wheel train (gear reduction ratio) of the hand-driving mechanism needs to be specifically configured based on the number of function display sections. If a hand-driving mechanism is specifically configured in this manner according to the number of function display sections, it may result in increased manufacturing costs. Further, a change in the reduction ratio affects the distance between the gears, thereby requiring a redesign of the gear support arrangement. That is, not only the wheel train but also the entire timepiece module, including the hand-driving mechanism, must be reconfigured, which significantly increases manufacturing costs.

One or more embodiments of the present invention have been conceived in view of the above, and an object thereof is to provide an electronic timepiece capable of changing the number of function display sections without requiring a dedicated hand-driving mechanism configured specifically for the number of function display sections.

### SUMMARY OF THE INVENTION

The invention disclosed in the present application in order to solve the above problem has various aspects, and a summary of representative of those aspects is as follows.
(1) An electronic timepiece includes a function hand, a plurality of function display sections provided to correspond to hand drive angles of the function hand, and a hand-driving mechanism configured to drive the function hand at each first hand drive angle, which is a first integer multiple of a unit hand drive angle, such that the function hand indicates each of a first number of positions arranged at equal intervals. The plurality of function display sections are provided in a second number that is greater than the first number. The function hand is capable of moving at hand drive angles that include a second hand drive angle, which is a second integer multiple of the unit hand drive angle, and a third hand drive angle, which is a third integer multiple of the unit hand drive angle and greater than the second hand drive angle.
(2) In (1), the electronic timepiece includes hand drive pulse output means configured to output a hand drive pulse in response to an operation of a user, where the hand drive pulse corresponds to the second hand drive angle and the third hand drive angle.
(3) In (1) or (2), the function hand is driven based on a combination of the second hand drive angle and the third hand drive angle so as to indicate each of the plurality of function display sections.
(4) In (3), a difference between the second hand drive angle and the third hand drive angle is equal to the unit hand drive angle.
(5) In (3) or (4), the function hand is driven at the third hand drive angle at two positions during one full rotation of the function hand.
(6) In any one of (1) to (5), the plurality of function display sections are symmetrically arranged with respect to a straight line connecting a 12 o'clock position and a 6 o'clock position.
(7) In any one of (1) to (5), the plurality of function display sections are asymmetrically arranged with respect to a straight line connecting a 12 o'clock position and a 6 o'clock position.
(8) In any one of (1) to (5), the function hand completes one full rotation in a clockwise or counterclockwise direction by being alternately driven at the second hand drive angle and the third hand drive angle.
(9) In any one of (1) to (8), the hand drive angle of the function hand is greatest before and after the 12 o'clock position or the 6 o'clock position. Each function display section includes a character and a design element around the character, the character indicating a function corresponding to the function display section. A width of the design element in a movement direction of the function hand is greater in the function display section positioned at the 12 o'clock position or the 6 o'clock position than in the function display sections positioned at other positions.
(10) In any one of (1) to (8), the hand drive angle of the function hand is greatest before and after a 3 o'clock position or ta 9 o'clock position. Each function display section includes a character and a design element around the character, where the character indicates a function corresponding to the function display section. A width of the design element in a movement direction of the function hand is greater in the function display section positioned at the 3 o'clock position or the 9 o'clock position than in the function display sections positioned at other positions.
(11) In any one of (1) to (10), the first number is six, and the second number is any one of seven, eight, or nine.
(12) In any one of (1) to (11), a timepiece module having the hand-driving mechanism is installed at a predetermined rotation arrangement angle. The electronic timepiece further includes a control circuit configured to store, as function hand control data, a combination of a control angle of the function hand and the plurality of function display sections, where the control angle is based on a combination of the second hand drive angle and the third hand drive angle, and control the function hand to indicate each of the function display positions by adding the rotation arrangement angle to the control angle.

### BRIEF DESCRIPTION OF THE DRAWINGS

FIG. 1 is a plan view illustrating an example of an electronic timepiece according to the present embodiment;

FIG. 2 is a block diagram showing an example of a configuration of the electronic timepiece according to the present embodiment;

FIG. 3 is a plan view of an enlarged sub-dial of the present embodiment;

FIG. 4 is a plan view of an enlarged sub-dial of a first modified example of the present embodiment;

FIG. 5 is a plan view of an enlarged sub-dial of a second modified example of the present embodiment;

FIG. 6 is a table showing hand drive intervals assigned to each function display section in cases where the number of display function sections is seven, eight, or nine;

FIG. 7 is a diagram showing an example of function name display when the number of display function sections is seven;

FIG. 8 is a diagram showing an example of function name display when the number of display function sections is seven;

FIG. 9 is a diagram showing an example of function name display when the number of display function sections is eight;

FIG. 10 is a diagram showing an example of function name display when the number of display function sections is nine;

FIG. 11 is a diagram showing an example of function name display when the number of display function sections is nine;

FIG. 12 is a table showing assignments of positions of function display sections and a function hand stored in a memory of a control circuit;

FIG. 13A is a diagram showing an example of an arrangement of the sub-dial;

FIG. 13B is a diagram showing an example of an arrangement of the sub-dial;

FIG. 13C is a diagram showing an example of an arrangement of the sub-dial;

FIG. 13D is a diagram showing an example of an arrangement of the sub-dial;

FIG. 13E is a diagram showing an example of an arrangement of the sub-dial; and

FIG. 14 is a table showing assignments of hand drive angles for respective function display section items corresponding to rotation angles of the timepiece module.

### DETAILED DESCRIPTION OF THE INVENTION

Embodiment of the present invention (hereinafter, referred to as "present embodiment") will be described below in detail with reference to the accompanying drawings.

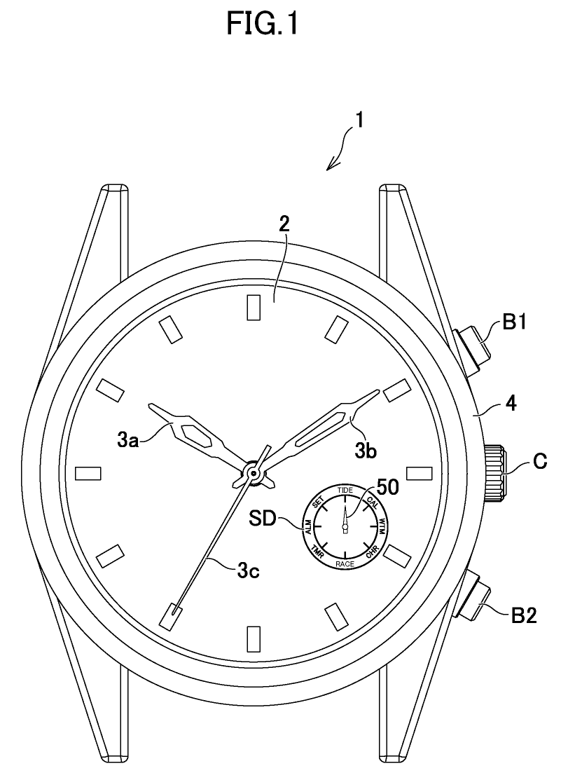

As shown in FIG. 1, an electronic timepiece 1 has an analog display system including a dial 2, an hour hand 3a, a minute hand 3b, and a second hand 3c that display the time. The electronic timepiece 1 also has an outer case 4 including a crown C and buttons B1 and B2 on its side surface.

A sub-dial SD, which serves as a function display part, is provided on the dial 2. The sub-dial SD includes multiple function display sections and a function hand 50 that moves to indicate those function display sections. The function display sections refer to portions that include scales indicated by the function hand 50, characters representing functions, and design elements such as colors applied around those characters. The user can confirm the currently selected function (mode) based on the position indicated by the function hand 50.

In the present embodiment, a function refers to additional functions other than the clock display function, such as calendar display function, world time display function, alarm function, timer function, chronograph function, tide graph function, and race timer function. In the example shown in FIG. 1, the characters indicating the functions, such as "ALM", are printed on the sub-dial SD. "ALM" is an abbreviation for "alarm" and indicates the alarm function.

The electronic timepiece 1 is not limited to the example as illustrated, and may further include a digital display section, for example. The electronic timepiece 1 may not have the crown C but instead have three buttons. Four or more buttons may be provided.

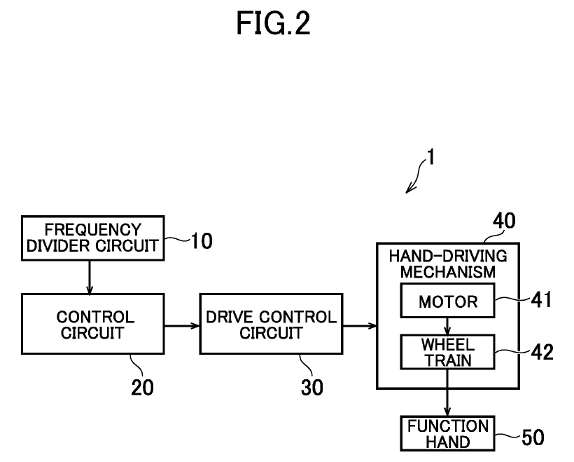

As shown in FIG. 2, the electronic timepiece 1 includes a frequency divider circuit 10, a control circuit 20, a drive control circuit 30, and a hand-driving mechanism 40. The hand-driving mechanism 40 includes a motor 41 and a wheel train 42 having a plurality of gears.

In the present embodiment, only the configuration for driving the function hand 50 will be described, but it is preferable that motors and wheel trains for driving time hands, such as the second hand 3c, are provided separately.

The frequency divider circuit 10 receives a predetermined clock signal that is output by an oscillator circuit including a quartz oscillator (not shown). The frequency divider circuit 10 divides the input clock signal.

The control circuit 20 is a microcomputer that incorporates a memory, for example, and controls the operation of the circuits included in the electronic timepiece 1 according to a program stored in the memory. The control circuit 20 outputs the clock signal from the frequency divider circuit 10 as a control signal. The control signal output from the control circuit 20 is input to the drive control circuit 30.

For example, the drive control circuit 30, which is a hand drive pulse output means, generates a hand drive pulse for driving the function hand 50 based on the control signal output from the control circuit 20, and outputs a signal corresponding to the hand drive pulse to the coil of the motor 41 to drive the motor 41. The motor 41 is preferably a step motor that is intermittently driven. The function hand 50 may be driven by the rotation of the motor 41 transmitted through the wheel train 42.

The control circuit 20 preferably monitors information regarding the current angle of the function hand 50. This allows the control circuit 20 to determine the angle from the function display section currently indicated by the function hand 50 to the next function display section to be indicated.

Although not described here, the electronic timepiece 1 may further include a battery as a power source and sensors.

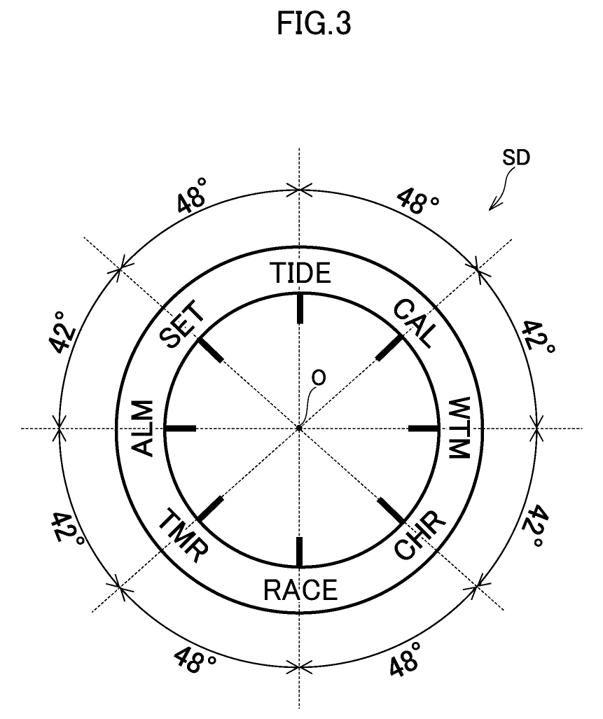

FIG. 3 is a plan view of an enlarged sub-dial of the present embodiment. As shown in FIG. 3, in this embodiment, eight function display sections respectively corresponding to eight functions (modes) are provided on the sub-dial SD. The eight function display sections are disposed in a circumferential direction around the circular sub-dial SD.

In the following, an "arrangement angle" refers to an angle formed by straight lines connecting the center O of the sub-dial SD and the scales of adjacent function display sections. A "hand drive angle" is an angle through which the function hand 50 moves when the function is switched, and is set according to the arrangement angle of the function display sections. Further, a "unit hand drive angle" is the minimum unit for driving the function hand 50. The hand-driving mechanism 40 of the present embodiment is configured such that the unit hand drive angle is set to 6°.

The function hand 50 moves in response to an operation of the user. The "operation of the user" includes, for example, pressing a button B1 or a button B2 once or multiple times consecutively, long-pressing the button B1 or the button B2, pressing the button B1 and the button B2 simultaneously, pulling out or pushing in the crown C, rotating the crown C, or combinations of these operations. For example, the functions may be switched sequentially according to the arrangement of eight function display sections in response to the operation of the user. Alternatively, functions corresponding to a specific function display section may be executed depending on the type or combination of operations of the user.

When the function of the electronic timepiece 1 is executed, the function hand 50 may point to the function display section corresponding to the executed function. Specifically, the function hand 50 may point to the scale included in the function display section. This allows the user to understand the currently selected function. For example, in FIG. 3, when the function hand 50 points to the 9 o'clock position, it can be confirmed that the currently selected function is "ALM" (alarm function).

Conventionally, the sub-dials with six function display sections arranged at equal intervals of 60° are known. In such a configuration, it is preferable to design the hand-driving mechanism so that the function hand moves in 60-degree increments. The hand drive angle of 60° can be achieved by setting the unit hand drive angle to 6° and driving the hand consecutively ten times. The function hand stops at the center position of each function display section.

In this regard, however, it has been difficult to apply a timepiece module having a hand-driving mechanism corresponding to six function display sections to the electronic timepiece 1 that displays more than six function display sections, for the following reasons. For example, if the electronic timepiece 1 has eight functions and accordingly includes eight function display sections, and the scales of the function display sections are arranged at equal intervals, the hand drive angle of the function hand 50 when switching functions is 45° (=360°÷8). In the hand-driving mechanism designed so that the unit hand drive angle is 6° as described above, it is not possible to achieve hand driving in 45-degree increments. This is because 45° is not an integer multiple of 6° and cannot be divided evenly. As such, it is necessary to prepare a dedicated hand-driving mechanism configured according to the eight function display sections. That is, it is not possible to use the conventional hand-driving mechanism, and a dedicated hand-driving mechanism is required to be newly configured and manufactured.

Accordingly, in the present embodiment, a configuration is adopted in which the electronic timepiece 1, having seven or more function display sections provided on the sub-dial SD, is implemented using the hand-driving mechanism 40 that is applicable to electronic timepieces having six function display sections on the sub-dial. In other words, the electronic timepiece 1 having seven or more functions is achieved without separately preparing a dedicated hand-driving mechanism designed according to the number of function display sections. As a result, the timepiece module including the hand-driving mechanism 40, which is designed to indicate six function display sections with the function hand, can be directly mounted in a new electronic timepiece 1 having more than six functions. As such, it is not necessary to develop a new timepiece module, and significant cost reduction can be achieved.

In this embodiment, the hand-driving mechanism 40, which is applicable to an electronic timepiece with six function display sections on the sub-dial, is configured such that the unit hand drive angle is set to 6°. In such a configuration, it is preferable to design the hand-driving mechanism so that the function hand moves in 60-degree increments. The hand drive angle of 60° can be achieved by setting the unit hand drive angle to 6° and driving the hand consecutively ten times.

When attempting to arrange seven or more function display sections at equal angular intervals using the hand-driving mechanism 40, which is configured such that the unit hand drive angle is set to 6°, the hand drive angle per function display section inevitably includes a decimal value. For example, in the case of seven function display sections, the hand drive angle is (360°/7)/6° ≒ 8.57. Accordingly, for the electronic timepiece with more than six function display sections, it is often not possible to arrange the function display sections at equal angular intervals with the unit hand drive angle of 6°. To address this, the function display sections are not arranged at equal angular intervals and the hand drive angle of the function hand 50 is controlled in accordance with the arrangement of the function display sections.

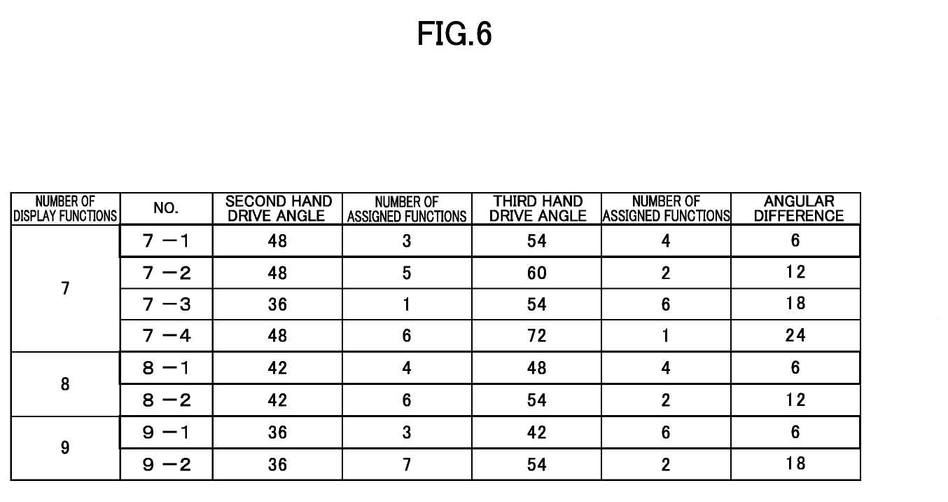

FIG. 6 is a table showing the hand drive intervals assigned to each function display section in cases where the number of display function sections is seven, eight, or nine. The table also shows how many function display sections are assigned to the second hand drive angle and the third hand drive angle, as well as the angular difference between the second and third hand drive angles. When the number of function display sections exceeds ten, the hand drive angle per function display section becomes smaller, resulting in narrower display widths. As such, in view of the character size and inconvenience of the user, such cases are omitted from the description in consideration of practical feasibility. However, the present embodiment is still applicable to such cases.

The table in FIG. 6 will be described in detail below. 7-1 shows a case in which the number of function display sections is seven, three function display sections are assigned a second hand drive angle of 48°, and four function display sections are assigned a third hand drive angle of 54°. The angular difference between the second and third hand drive angles is 6°. 7-2 shows a case in which the number of function display sections is seven, five function display sections are assigned a second hand drive angle of 48°, and two function display sections are assigned a third hand drive angle of 60°. The angular difference between the second and third hand drive angles is 12°. 7-3 shows a case in which the number of function display sections is seven, one function display section is assigned a second hand drive angle of 36°, and six function display sections are assigned a third hand drive angle of 54°. The angular difference between the second and third hand drive angles is 6°. 7-4 shows a case in which the number of function display sections is seven, six function display sections are assigned a second hand drive angle of 48°, and one function display section is assigned a third hand drive angle of 72°. The angular difference between the second and third hand drive angles is 6°. 8-1 shows a case in which the number of function display sections is eight, four function display sections are assigned a second hand drive angle of 42°, and four function display sections are assigned a third hand drive angle of 48°. The angular difference between the second and third hand drive angles is 6°. 8-2 shows a case in which the number of function display sections is eight, six function display sections are assigned a second hand drive angle of 42°, and two function display sections are assigned a third hand drive angle of 54°. The angular difference between the second and third hand drive angles is 12°. 9-1 shows a case in which the number of function display sections is nine, three function display sections are assigned a second hand drive angle of 36°, and six function display sections are assigned a third hand drive angle of 42°. The angular difference between the second and third hand drive angles is 6°. 9-2 shows a case in which the number of function display sections is nine, seven function display sections are assigned a second hand drive angle of 36°, and two function display sections are assigned a third hand drive angle of 54°. The angular difference between the second and third hand drive angles is 18°.

When the angular difference between the second and third hand drive angles increases, the variation in the widths of the function display sections becomes more pronounced. This may cause a sense of visual inconsistency for the user when viewing the sub-dial. That is, a smaller angular difference between the second and third hand drive angles is preferable, as it results in less variation in the widths of the function display sections, making them appear more uniform. The smallest angular difference of 6° between the second and third hand drive angles, which is equal to the unit hand drive angle, is found in 7-1 when the number of function display sections is seven, in 8-1 when the number of function display sections is eight, and in 9-1 when the number of function display sections is nine. Accordingly, in order to make the widths of all function display sections appear as uniform as possible, the combination with the smallest angular difference between the second and third hand drive angles is selected. Further, it is preferable that the angular difference between the second and the third hand drive angles is equal to the unit hand drive angle. This reduces the visual inconsistency perceived by the user when viewing the sub-dial.

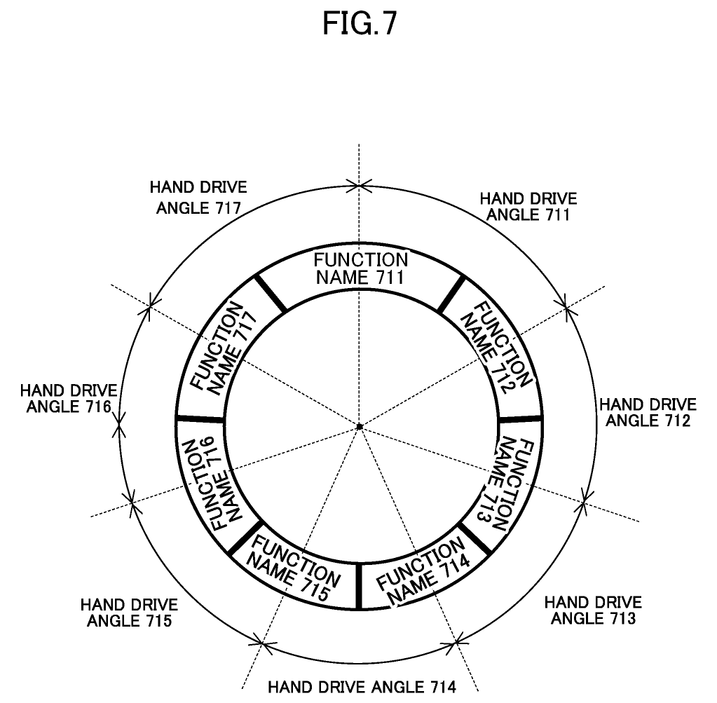

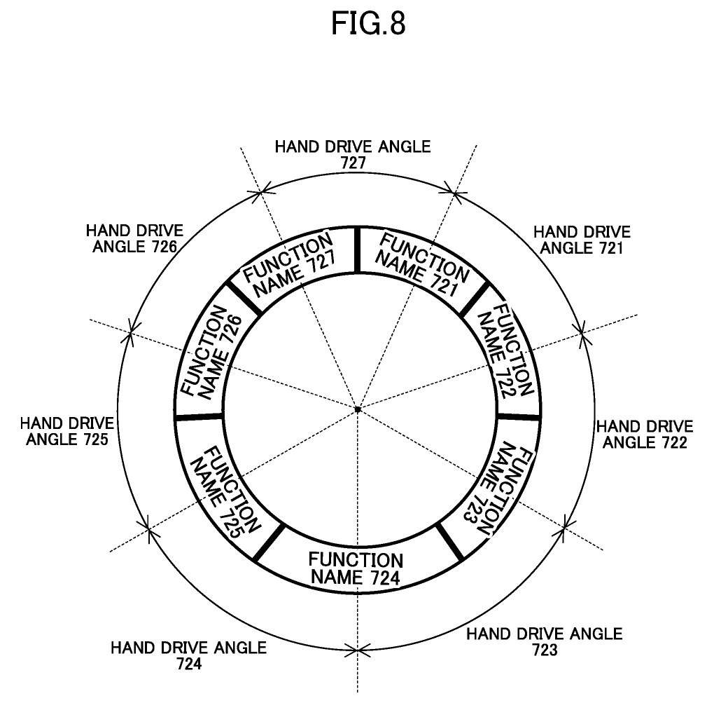

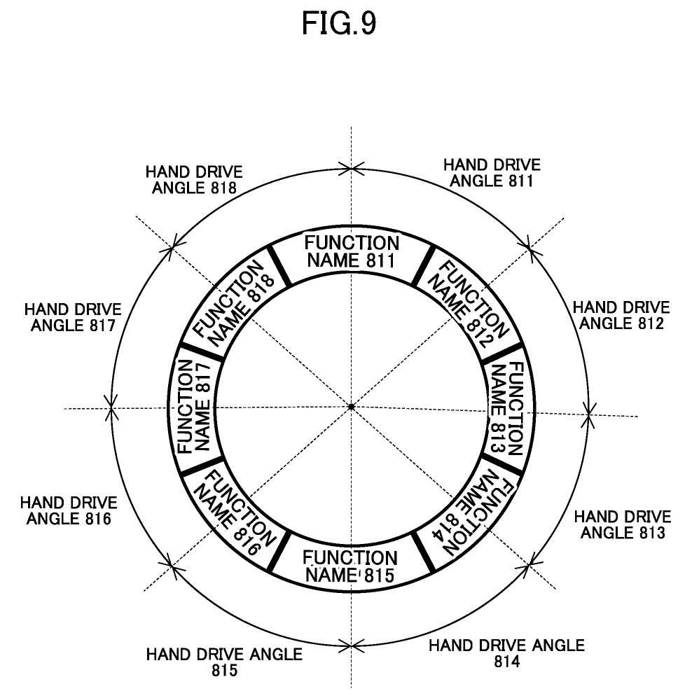

FIGS. 7 and 8 show examples of function name display when the number of function display sections is seven, while FIG. 9 shows an example when the number of function display sections is eight, and FIG.s 10 and 11 show examples when the number of function display sections is nine.

FIG. 7 shows one function display section at the 12 o'clock position (function name 711) and two function display sections near the 6 o'clock position (function names 714 and 715). FIG. 8 shows two function display sections at the 12 o'clock position (function names 721 and 727) and one function display section near the 6 o'clock position (function name 724).

FIG. 9 shows one function display section at each of the 12 o'clock position and the 6 o'clock position (function names 811 and 815).

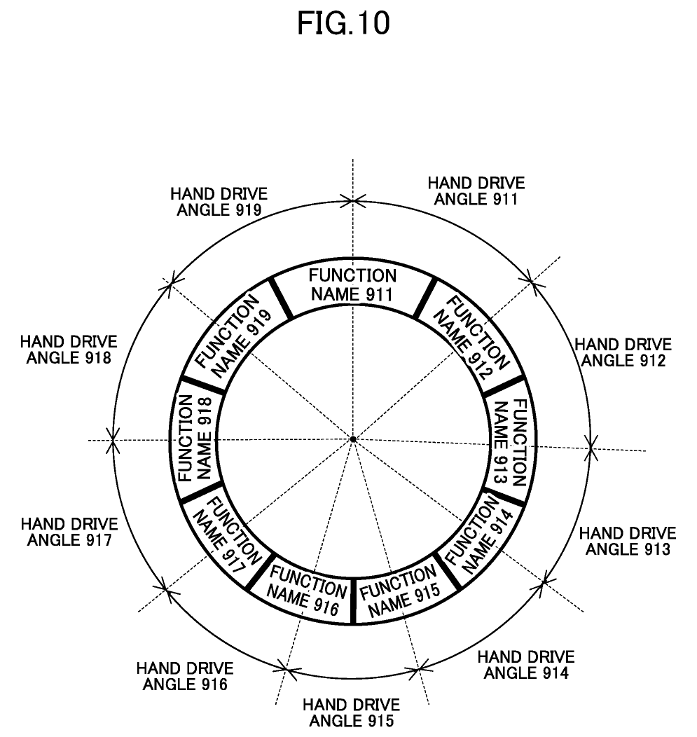

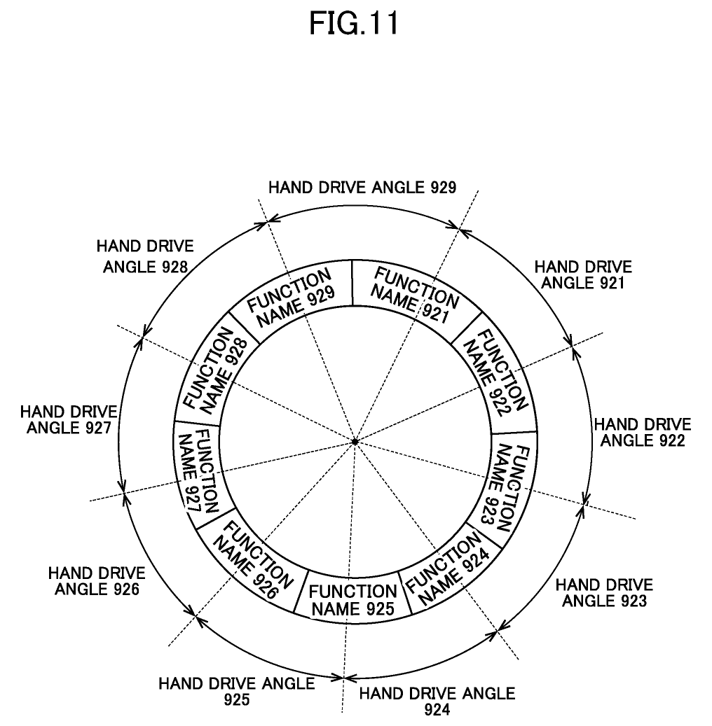

FIG. 10 shows one function display section at the 12 o'clock position (function name 911) and two function display sections near the 6 o'clock position (function names 915 and 916). FIG. 11 shows two function display sections near the 12 o'clock position (function names 921 and 929) and one function display section at the 6 o'clock position (function name 925).

In FIGS. 7 to 11, the dashed lines indicate the positions at which the function hands stops and the hand drive angles 711 to 717, 721 to 727, 811 to 818, 911 to 919, and 921 to 929 represent the respective hand drive angles for each function display section. FIGS. 7 to 11 are schematic diagrams, and the spacing of the dashed lines shown therein does not strictly represent each hand drive angle.

Regardless of whether the number of display functions is seven, eight, or nine, the function display sections located at or near the 12 o'clock and 6 o'clock positions present upright characters oriented with the 12 o'clock direction as the top, or characters at angles close to upright, making them easy to read. In contrast, characters at other positions are displayed in rotated or tilted orientations. As such, the function display section located at or near the 12 o'clock and 6 o'clock positions are often assigned to important functions, such as characteristic functions, frequently used functions, and new functions.

Accordingly, the combination with the smallest angular difference between the second hand drive angle and the third hand drive angle is selected according to the number of function display sections, and the function display sections at or near the 12 o'clock and 6 o'clock positions are assigned the third hand drive angle, which is greater than the second hand drive angle. This allows important functions to be displayed over a wider area, making it possible to increase the number of characters, enlarge the character size, or use bolder fonts. As a result, the user can more easily recognize the displayed information at a glance.

In the following, the case where the number of function display sections is eight will be described in detail. In the present embodiment, 8-1 in FIG. 6 shows a combination of 48° and 42° for the arrangement angle of the function display sections, and the hand drive angle of the function hand 50 is controlled accordingly. The function hand 50 is capable of moving at hand drive angles of 48° and 42°, respectively corresponding to the arrangement angles of 48° and 42°. The hand drive angle of 48° can be achieved by driving the hand by the unit hand drive angle of 6° consecutively eight times. The hand drive angle of 42° can be achieved by driving the hand by the unit hand drive angle of 6° consecutively seven times.

Preferably, the function hand is driven by the unit hand drive angle in response to a unit hand drive pulse output from the drive control circuit 30. As such, the unit hand drive pulse may be output seven times in order to drive the function hand 50 by a hand drive angle of 42°, and may be output eight times in order to drive the function hand 50 by the hand drive angle of 48°.

In 8-1 of FIG. 6, there are four arrangement angles of 48° and four arrangement angles of 42°, and thus, in FIG. 9, the hand drive angles 811, 814, 815, and 818 are set to 48°, and the hand drive angles 812, 813, 816, and 817 are set to 42°. This makes it possible to increase the display widths of function names 811 and 815, which are shown in an upright or nearly upright orientation, thereby allowing these function names to be displayed in larger size and improving their readability. Further, the function display sections can be arranged symmetrically on the left and right sides of the straight line connecting the 12 o'clock position and the 6 o'clock position.

When selecting 7-1 of FIG. 6 for the seven display function sections in FIG. 7, there are four arrangement angles of 54° and three arrangement angles of 48°, and thus, in FIG. 7, the hand drive angles 711, 713, 715, and 717 are set to 54° and the hand drive angles 712, 714, and 716 are set to 48°. This makes it possible to increase the display widths of function names 711, 714, and 715, which are shown in an upright or nearly upright orientation, thereby allowing these function names to be displayed in larger size and improving their readability. Further, the function display sections can be arranged symmetrically on the left and right sides of the straight line connecting the 12 o'clock position and the 6 o'clock position.

In the case of seven display function sections in FIG. 8, the hand drive angles 721, 723, 724, and 726 are set to 54°, and the hand drive angles 722, 725, and 727 are set to 48° in FIG. 8. This makes it possible to increase the display widths of function names 721, 724, and 727, which are shown in an upright or nearly upright orientation, thereby allowing these function names to be displayed in larger size and improving their readability. Further, the function display sections can be arranged symmetrically on the left and right sides of the straight line connecting the 12 o'clock position and the 6 o'clock position.

When selecting 9-1 of FIG. 6 for the nine display function sections in FIG. 10, there are six arrangement angles of 42° and three arrangement angles of 36°, and thus, in FIG. 10, the hand drive angles 911, 914, 916, and 919 are set to 42°, the hand drive angles 912 and 918 are set to 42°, and the hand drive angles 913, 915, and 917 are set to 36° Alternatively, the hand drive angles 911, 914, 916, and 919 may be set to 42°, the hand drive angles 913 and 917 may be set to 42°, and the hand drive angles 912, 915, and 918 may be set to 36°. This makes it possible to increase the display widths of function names 911, 915, and 916, which are shown in an upright or nearly upright orientation, thereby allowing these function names to be displayed in larger size and improving their readability. Further, the function display sections can be arranged symmetrically on the left and right sides of the straight line connecting the 12 o'clock position and the 6 o'clock position.

In the case of nine display function sections in FIG. 11, the hand drive angles 921, 924, 925, and 928 are set to 42°, the hand drive angles 923 and 926 are set to 42°, and the hand drive angles 922, 927, and 929 are set to 36° in FIG. 11. Alternatively, the hand drive angles 921, 924, 925, and 928 may be set to 42°, the hand drive angles 922 and 927 may be set to 42°, and the hand drive angles 923, 926, and 929 may be set to 36°. This makes it possible to increase the display widths of function names 921, 925, and 929, which are shown in an upright or nearly upright orientation, thereby allowing these function names 921, 925, and 929 to be displayed in larger size and improving their readability. Further, the function display sections can be arranged symmetrically on the left and right sides of the straight line connecting the 12 o'clock position and the 6 o'clock position.

The electronic timepiece 1 according to the present embodiment described above eliminates the need for a new configuration of a hand-driving mechanism even when the number of function display sections is increased. That is, the electronic timepiece 1 can be implemented with an increased number of function display sections without separately preparing a hand-driving mechanism that includes a wheel train with a modified reduction ratio. This helps to prevent an increase in manufacturing costs. Further, the hand-driving mechanism 40 can be standardized, and thus inventory management and related operations can be simplified.

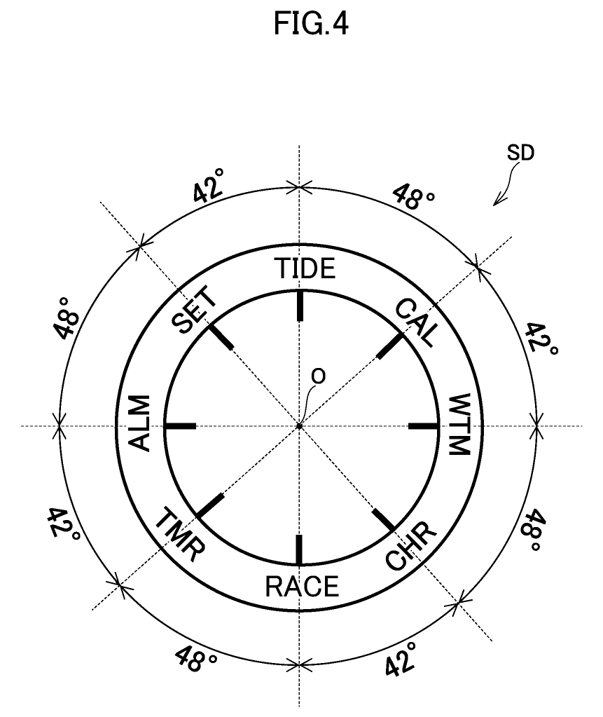

FIG. 4 is a plan view of an enlarged sub-dial of the first modified example of the present embodiment. FIG. 3 shows the example in which the function display sections are arranged to be symmetrical about the straight line connecting the 12 o'clock and 6 o'clock positions. The first modified example shows the example in which the function display sections are arranged to be asymmetrical about the same straight line. In the first modified example, the arrangement angles of the adjacent function display sections are alternately set along the movement direction of the function hand 50. Specifically, the function display sections are set so that the arrangement angles of 42° and 48° alternate. As a result, the function hand 50 completes one full rotation in the clockwise or counterclockwise direction by being alternately driven at the second hand drive angle of 42° and the third hand drive angle of 48°.

When viewing the function display sections illustrated in FIGS. 3 and 4, the user is less likely to perceive any discomfort resulting from the non-equidistant arrangement angles. This is because there is no substantial difference in the arrangement angles between the case of equidistant angles of 45° and the case of non-equidistant angles formed by a combination of 42° and 48°. In the case of non-equidistant arrangement, it is preferable that the difference between the respective arrangement angles is less than or equal to the unit hand drive angle. The arrangement angles of 42° and 48° shown in FIGS. 3 and 4 may be alternatively arranged in reverse order.

In the above description, in order to arrange all function display sections with approximately uniform widths, the combination of the second and third hand drive angles having the smallest angular difference is selected according to the number of function display sections. The following describes the selection of the second and third hand drive angles in a case where only the function display section at the 12 o'clock position or the 6 o'clock position is to be widened.

When the display widths of specific function names, such as 711 in FIG. 7 724 in FIGS. 8, 811 or 815 in FIGS. 9, 911 in FIG. 10, and 925 in FIG. 11, are to be made particularly wider, a combination is selected from the table in FIG. 6 in which two function display sections are assigned the third hand drive angle. Specifically, 7-2 is selected for the case where the number of function display sections is seven, 8-2 is selected for the case where the number of display functions is eight, and 9-2 is selected for the case where the number of display functions is nine.

In 8-2 of FIG. 6, there are two arrangement angles of 54° and six arrangement angles of 42°, and thus, the hand drive angles 811 and 818 are set to 54° and the other hand drive angles are set to 42° in order to widen the display width of the function name 811 in FIG. 9. Alternatively, the hand drive angles 814 and 815 are set to 54° and the other hand drive angles are set to 42° in order to widen the display width of the function name 815. This makes it possible to increase the display widths of function names 811 and 815, which are shown in an upright or nearly upright orientation, thereby allowing these function names to be displayed in larger size and improving their readability. Further, the function display sections can be arranged symmetrically on the left and right sides of the straight line connecting the 12 o'clock position and the 6 o'clock position.

When selecting 7-2 of FIG. 6 for the seven display function sections in FIG. 7, there are two arrangement angles of 60° and five arrangement angles of 48°, and thus, in FIG. 7, the hand drive angles 711 and 717 are set to 60° and the other hand drive angles are set to 48°. This makes it possible to increase the display widths of function name 711, which is shown in an upright or nearly upright orientation, thereby allowing the function name to be displayed in larger size and improving their readability. Further, the function display sections can be arranged symmetrically on the left and right sides of the straight line connecting the 12 o'clock position and the 6 o'clock position.

In the case of seven display function sections in FIG. 8, the hand drive angles 723 and 724 are set to 60°, and the other hand drive angles are set to 48° in FIG. 7. This makes it possible to increase the display widths of function name 724, which is shown in an upright or nearly upright orientation, thereby allowing the function name to be displayed in larger size and improving their readability. Further, the function display sections can be arranged symmetrically on the left and right sides of the straight line connecting the 12 o'clock position and the 6 o'clock position.

When selecting 9-2 of FIG. 6 for the nine display function sections in FIG. 10, there are two arrangement angles of 54° and seven arrangement angles of 36°, and thus, in FIG. 10, the hand drive angles 911 and 919 are set to 54° and the other hand drive angles are set to 36°. This makes it possible to increase the display widths of function name 911, which is shown in an upright or nearly upright orientation, thereby allowing the function name to be displayed in larger size and improving their readability. Further, the function display sections can be arranged symmetrically on the left and right sides of the straight line connecting the 12 o'clock position and the 6 o'clock position.

In the case of nine display function sections in FIG. 11, the hand drive angles 924 and 925 are set to 54°, and the other hand drive angles are set to 36° in FIG. 11. This makes it possible to increase the display widths of function name 925, which is shown in an upright or nearly upright orientation, thereby allowing the function name to be displayed in larger size and improving their readability. Further, the function display sections can be arranged symmetrically on the left and right sides of the straight line connecting the 12 o'clock position and the 6 o'clock position.

### In the following, specific examples will be described

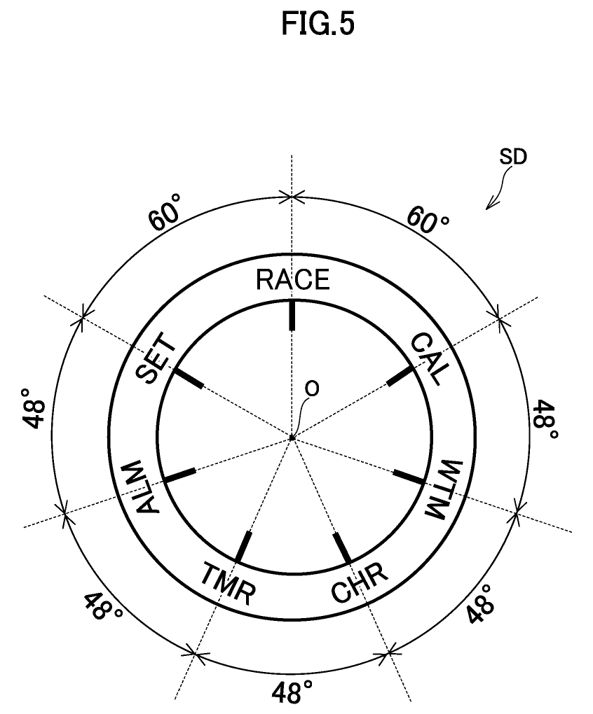

FIG. 5 is a plan view of an enlarged sub-dial of the second modified example of the present embodiment. FIG. 5 shows an example in which 7-2 of FIG. 6 is selected with the arrangement of seven function display sections in FIG. 7, where five arrangement angles are set to 48° and two arrangement angles are set to 60°. The hand drive angle of 60° corresponding to the arrangement angle of 60° can be achieved by driving the hand by the unit hand drive angle of 6° consecutively ten times.

In the arrangement of function display sections shown in FIG. 5, the visibility of "RACE" positioned at 12 o'clock can be improved and made more prominent. In the second modification, the difference between the arrangement angle of 48° and the arrangement angle of 60° is 12°, which is larger than the difference of 6° between the arrangement angles of 42° and 48° shown in FIGS. 3 and 4. In this manner, the difference between the two types of arrangement angles (hand drive angles) is increased, and the width of specific function display section can be thereby increased, making them more prominent. The arrangement shown in FIG. 5 is merely an example, and other function display section may be arranged at the 12 o'clock position instead of "RACE".

The size and width of the characters and design elements included in the function display sections may be determined according to the spacing of the arrangements of the function display sections. For example, the width of the design element in the movement direction of the function hand 50 is preferably greater in the function display section arranged at the 12 o'clock or 6 o'clock position than for those arranged at other positions. This improves visibility of the function display section arranged at the 12 o'clock or 6 o'clock position. As shown in FIG. 5, such a design is preferably applied to configurations where the arrangement angle of the function display sections (the hand drive angle of the function hand 50) is largest around the 12 o'clock position.

As mentioned above, it is possible to eliminate the need to design a dedicated hand-driving mechanism based on the number of function display sections. That is, the hand-driving mechanism 40 configured to drive the function hand 50 at equal intervals of 60° can be used without modification.

Referring to FIGS. 3 to 5, three examples of arrangement patterns for function display sections are provided, but they are not limited to these. It is sufficient that the function hand 50 be capable of moving through hand drive angles that include a second hand drive angle, which is a second integer multiple of the unit hand drive angle, and a third hand drive angle, which is a third integer multiple of the unit hand drive angle and greater than the second hand drive angle. The hand drive angles of the function hand 50 and the corresponding arrangement angles of the function display section may include three or more types. For example, the arrangement angles may be 42° at two positions, 48° at two positions, and 60° at three positions.

In the above embodiment and its modifications, the number of function display sections is described as being a second number, which is seven, eight, or nine, and greater than a first number, which is six, but the number of function display sections is not limited to this and may be ten or more. However, in consideration of the character size required for visual recognition, it is preferable that the number of function display sections be less than ten.

In the above embodiment and its modifications, the hand-driving mechanism 40 is configured such that the unit hand drive angle is 6°, but the unit hand drive angle is not limited to 6°. For example, the unit hand drive angle may be set to 3° or 12° by adjusting the reduction ratio of the gears included in the hand-driving mechanism 40.

To enable the timepiece module to be used in a new electronic timepiece 1 in which the positions of the sub-dial for function display vary depending on the design of the dial, the timepiece module is configured to be arranged with a rotated orientation. Accordingly, the display positions of the respective functions also vary, and thus the assignments of the positions of the function display sections and the function hand are stored in the memory of the control circuit 20 so that they can be changed as needed.

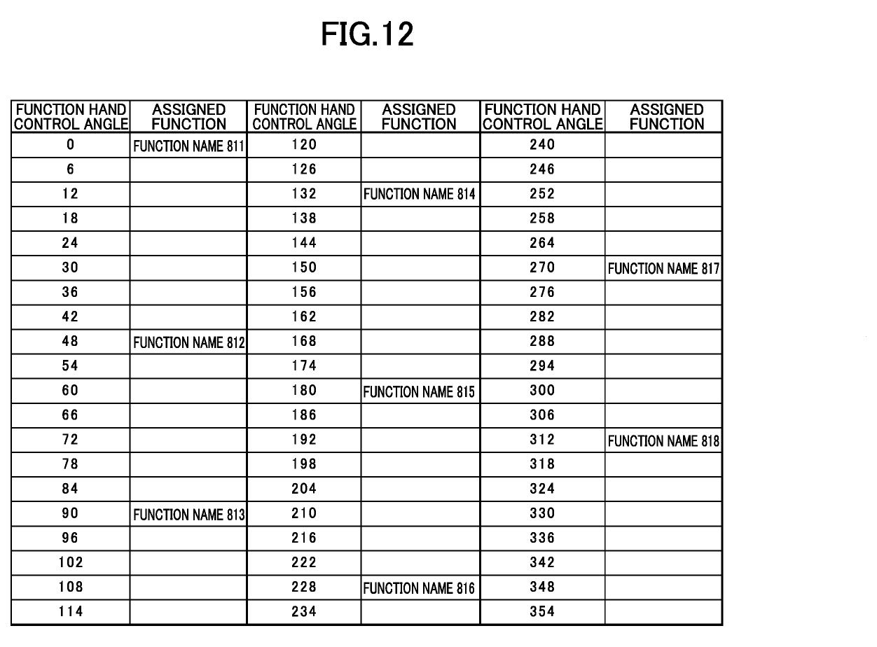

FIG. 12 is a table showing the assignments of the positions of the function display sections and the function hand stored in the memory of the control circuit 20. As an example, the case is described in which eight function display sections are arranged as shown in FIG. 9 and the combination of 8-1 in FIG. 6 is selected. In the combination of 8-1, there are four arrangement angles of 48° and four arrangement angles of 42°, and thus, in FIG. 9, the hand drive angles 811, 814, 815, and 818 are set to 48°, and the hand drive angles 812, 813, 816, and 817 are set to 42°.

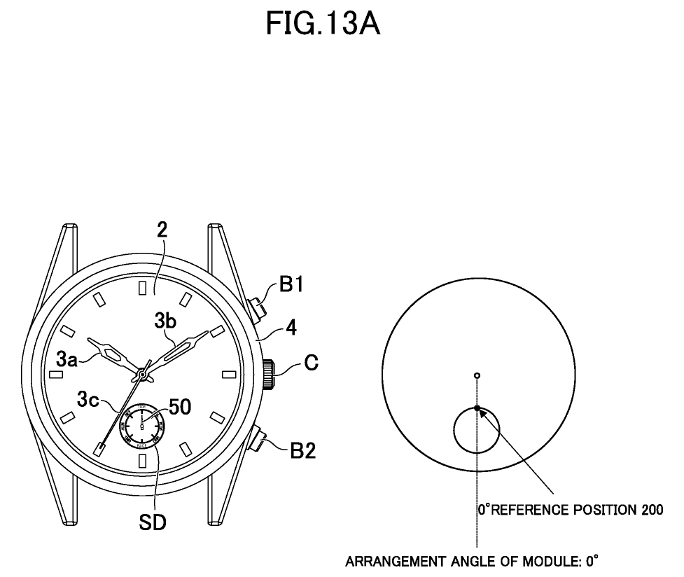

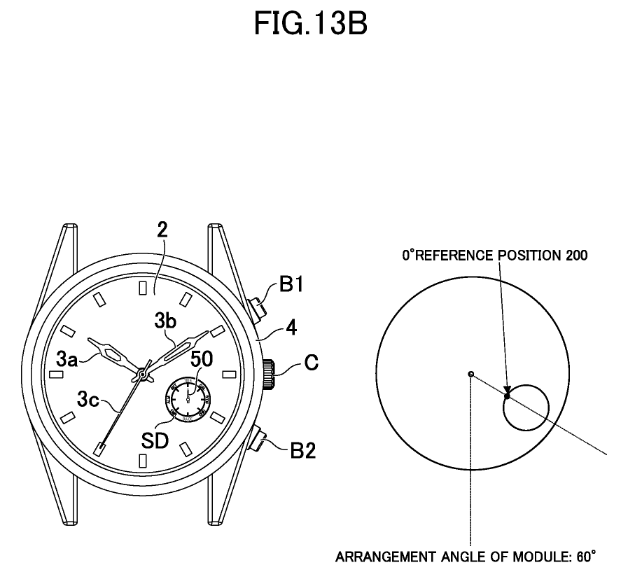

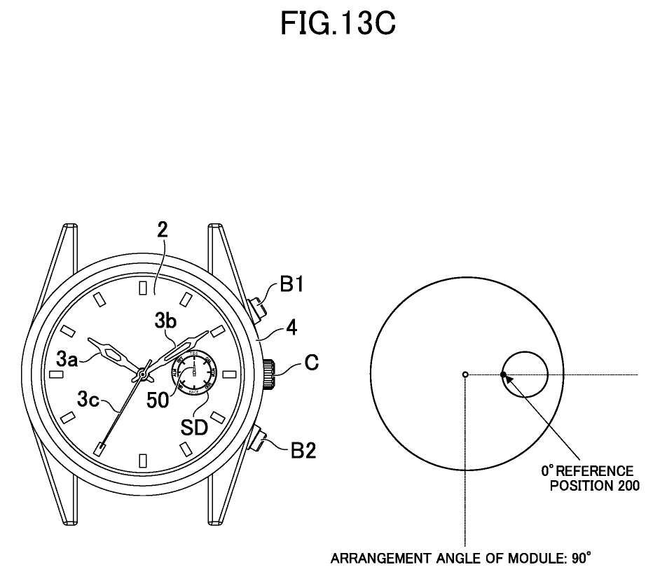

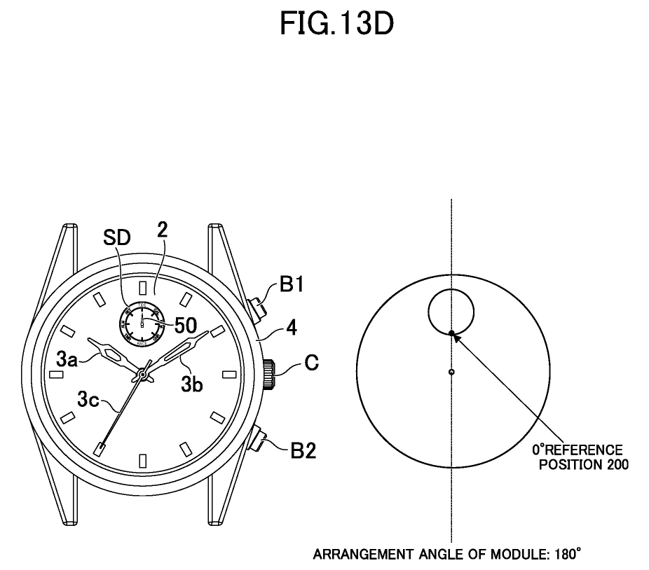

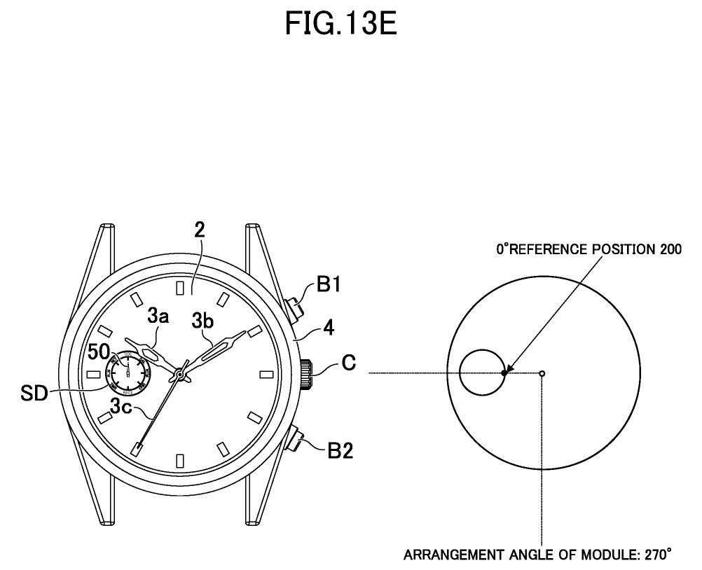

As shown by 0° reference position 200 in FIG. 13A, in the present embodiment, the position at which the function hand points to the rotation center of the hour, minute, and second hands of the electronic timepiece corresponds to 0° reference position of the control angle of the function hand. The control angle of the function hand is the control angle for each step of the function hand operating at the unit hand drive angle of 6°. The display assignment for the control angle of the function hand is stored, for example, the function name 811 is stored as 0°, and the function name 812 is stored as 48°. Based on the stored data shown in FIG. 12, when indicating the function name 811, the control circuit 20 drives the motor via the hand-driving mechanism 40 to move the function hand to the 0° position. Similarly, when indicating function name 812 with the function hand, the motor is driven by the hand-driving mechanism 40 to move the function hand to the 48° position.

In the present embodiment, when the timepiece module having the hand-driving mechanism corresponding to six function display sections is also used in a new timepiece having more than six functions, the position of the sub-dials for displaying the functions can be changed by rotating the timepiece module. The diagrams on the right side of FIGS. 13A, 13B, 13C, 13D, and 13E, show the positions of the sub-dials of the function display sections when the timepiece module is rotated counterclockwise by 0°, 60°, 90°, 180°, and 270°.

As can be seen from the 0° reference position 200 in FIG. 13A, the 0° reference position of the control angle of the function hand varies depending on the arrangement angle of the timepiece module. As such, it is necessary to change the assignment of the positions of the function display sections and the function hand in the sub-dial. For example, as shown in FIG. 13C, when the timepiece module is arranged at a rotation arrangement angle of 90°, the function name 811, which is positioned at the top of the sub-dial, is reassigned to the 90° control angle position of the function hand.

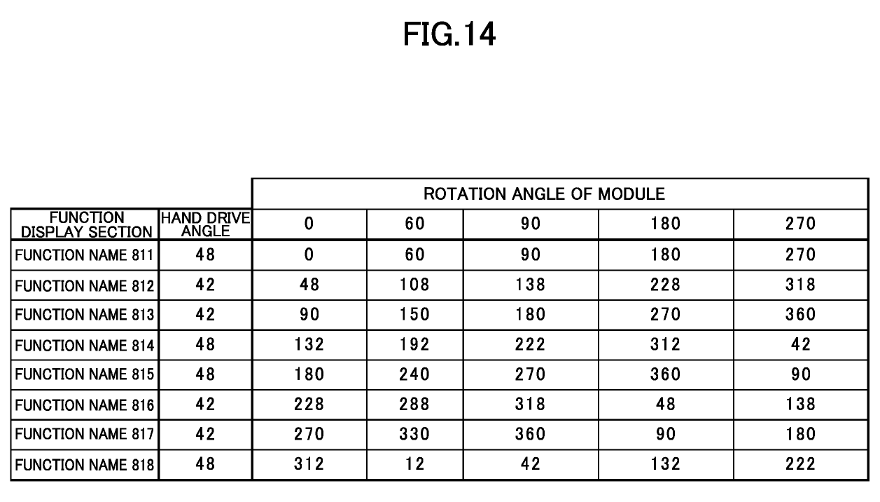

FIG. 14 is a table showing the assignments of the hand drive angles for each function display section item corresponding to the rotation angle of the timepiece module. FIG. 14 also shows the case in which eight function display sections are arranged as shown in FIG. 9 and the combination of 8-1 in FIG. 6 is selected. The hand drive angles for the function names 811, 814, 815, and 818 are set to 48°, and the other hand drive angles are set to 42°. As such, when the rotation angle for arranging the timepiece module is 0°, the function names 811 through 818 are sequentially assigned to control angles of 0°, 48°, 90°, 132°, 180°, 228°, 270°, and 312°, which correspond to the respective positions of the function hand, and stored accordingly.

When the timepiece module is arranged at a rotation arrangement angle of 60°, the function names 811 through 818 are sequentially assigned to the angles 60°, 108°, 150°, 192°, 240°, 288°, 330°, and 12°, which are obtained by adding the rotation angle 60° to the control angles of the function hand when the rotation angle is 0°, and these assignments are stored accordingly. Similarly, when the timepiece module is arranged at the rotation arrangement angles of 90°, 180°, or 270°, the function names 811 through 818 are also sequentially assigned to the angles obtained by adding the respective rotation arrangement angles of the timepiece module to the control angles of the function hand used when the rotation angle is 0°, and these assignments are stored accordingly.

In the present description, the 0° control angle of the function hand is explained as the position pointing to the rotational center of the hour, minute, and second hands of the electronic timepiece, but this is merely an example. The 0° control angle of the function hand simply defines a reference position, and may be set to any position to achieve the same functional effect.

According to the above embodiment, the timepiece module having the hand-driving mechanism for driving the function hand to six function display positions arranged at equal intervals is mounted in the electronic timepiece having more than six function display sections. The function hand is driven to indicate the function display sections by combining the second hand drive angle and the third hand drive angle. The function hand control data indicating the combinations of the control angles of the function hand based on the second and third hand drive angles and the respective function display sections are stored. Based on the above configuration, when the timepiece module is arranged at a rotation arrangement angle within the electronic timepiece, it is possible to accurately indicate each function display section with the function hand by adding the rotation arrangement angles to the control angles of the function hand stored in the function hand control data.

Accordingly, even when the timepiece module having the hand-driving mechanism corresponding to six function display sections is also used in a new electronic timepiece having more than six functions, it is possible to easily change the position of the sub-dial displaying the functions by rotating the timepiece module. This configuration eliminates the need to design a dedicated hand-driving mechanism corresponding to the number of function display sections.

What is claimed is:

1. An electronic timepiece comprising:
a function hand;
a plurality of function display sections provided to correspond to hand drive angles of the function hand; and
a hand-driving mechanism configured to drive the function hand at each first hand drive angle, which is a first integer multiple of a unit hand drive angle, such that the function hand indicates each of a first number of positions arranged at equal intervals, wherein
the plurality of function display sections are provided in a second number that is greater than the first number, and
the function hand is capable of moving at hand drive angles that include a second hand drive angle, which is a second integer multiple of the unit hand drive angle, and a third hand drive angle, which is a third integer multiple of the unit hand drive angle and greater than the second hand drive angle.

2. The electronic timepiece according to claim 1, comprising a hand drive pulse output component configured to output a hand drive pulse in response to an operation of a user, the hand drive pulse corresponding to the second hand drive angle and the third hand drive angle.

3. The electronic timepiece according to claim 1, wherein
the function hand is driven based on a combination of the second hand drive angle and the third hand drive angle so as to indicate each of the plurality of function display sections.

4. The electronic timepiece according to claim 3, wherein
a difference between the second hand drive angle and the third hand drive angle is equal to the unit hand drive angle.

5. The electronic timepiece according to claim 3, wherein
the function hand is driven at the third hand drive angle at two positions during one full rotation of the function hand.

6. The electronic timepiece according to claim 1, wherein
the plurality of function display sections are symmetrically arranged with respect to a straight line connecting a 12 o'clock position and a 6 o'clock position.

7. The electronic timepiece according to claim 1, wherein
the plurality of function display sections are asymmetrically arranged with respect to a straight line connecting a 12 o'clock position and a 6 o'clock position.

8. The electronic timepiece according to claim 1, wherein
the function hand completes one full rotation in a clockwise or counterclockwise direction by being alternately driven at the second hand drive angle and the third hand drive angle.

9. The electronic timepiece according to claim 1, wherein
the hand drive angle of the function hand is greatest before and after the 12 o'clock position or the 6 o'clock position,
each function display section includes a character and a design element around the character, the character indicating a function corresponding to the function display section, and
a width of the design element in a movement direction of the function hand is greater in the function display section positioned at the 12 o'clock position or the 6 o'clock position, than in the function display sections positioned at other positions.

10. The electronic timepiece according to claim 1, wherein
the hand drive angle of the function hand is greatest before and after a 3 o'clock position or a 9 o'clock position,
each function display section includes a character and a design element around the character, the character indicating a function corresponding to the function display section, and
a width of the design element in a movement direction of the function hand is greater in the function display section positioned at the 3 o'clock position or the 9 o'clock position, than in the function display sections positioned at other positions.

11. The electronic timepiece according to claim 1, wherein
the first number is six, and the second number is any one of seven, eight, or nine.

12. The electronic timepiece according to claim 1, wherein
a timepiece module having the hand-driving mechanism is installed at a predetermined rotation arrangement angle, and
the electronic timepiece further includes a control circuit configured to:
store, as function hand control data, a combination of a control angle of the function hand and the plurality of function display sections, the control angle being based on a combination of the second hand drive angle and the third hand drive angle, and
control the function hand to indicate each of the function display positions by adding the rotation arrangement angle to the control angle.
